(19) United States
(12) Patent Application Publication
(10) Pub. No.: US 2007/0129913 A1
(43) Pub. Date: Jun. 7, 2007

(54) Supply apparatus and receiving apparatus

(76) Inventors: Hideaki Yamamoto, Yamanashi (JP); Shinichi Aono, Yamanashi (JP); Susumu Oka, Yamanashi (JP); Koji Tsukawaki, Yamanashi (JP); Hideki Baba, Fukuoka (JP); Takashi Sasaki, Yamanashi (JP); Nobuyoshi Kobayashi, Saga (JP); Yoichi Sugitomo, Hyogo (JP)

Correspondence Address: WENDEROTH, LIND & PONACK L.L.P., 2033 K. STREET, NW, SUITE 800, WASHINGTON, DC, 20006, US

(21) Appl. No.: 11/540,601

(22) Filed: Oct. 2, 2006

(30) Foreign Application Priority Data
Dec. 6, 2005 (JP) 2005-352689

(51) Int. Cl. G21C 17/00

(52) U.S. Cl. 702/184

(57) ABSTRACT

The present invention provides a supply apparatus and a receiving apparatus for enabling a user of a production apparatus such as a component mounter, to visually comprehend accurate support information provided from a manufacturer in accordance with the life cycle of the production apparatus, and realize more appropriate production apparatus maintenance. In the support information received by the receiving apparatus, the period after the purchase of the component mounter is displayed in the life cycle, and a list of equipment productivity-related items as well as diagnosis-related items is displayed as support items which are predicted for such life cycle. Moreover, as equipment productivity-related items, optimal support information for each year of use of the component mounter are indicated such as: “training” for training the component mounter user; “warranted inspection” for inspection within the warranty period; “maintenance inspection” for inspection under a contract, and “nozzle unit recycling” corresponding to the timing for recycling of the nozzle unit.

### BACKGROUND OF THE INVENTION

(1) Field of the Invention

The present invention relates to a supply apparatus that supplies accurate support information to a user of a production apparatus such as a component mounter, and to a receiving apparatus, included in a production apparatus to be maintained, that receives the support information, in order to realize high efficiency and high quality production in the production apparatus and in a production line in which a plurality of production apparatuses are linked in a process order.

(2) Description of the Related Art

Conventionally, in a production apparatus such as a component mounter, a component inserting machine, and a semiconductor mounter (description to be carried out hereafter using the component mounter), it is common to have, as a countermeasure for trouble, a response such as carrying out a countermeasure on a case by case basis after trouble has occurred, or predicting the occurrence of trouble and stocking components in advance.

In such cases, in spite of being able to prevent the occurrence of trouble by carrying out preventive maintenance on the component mounter, there are many instances where the component mounter deteriorates to a critical condition since a response is carried out after trouble has occurred. Moreover, in such a case, the user of a component mounter is also faced with severe financial problems such as increased component mounter repair costs as well as the inability to attain planned production figures.

Furthermore, in the use of the conventional component mounter, it is common to uphold operation at the performance level of the conventional mounter even when the component mounter has been in operation for some time. On the other hand, when some time has passed after a component mounter's purchase, the manufacturer of the component mounter carries out improvements such as adding new functions to old-model component mounters, by providing new services with the advancements in technology.

In addition, details are disclosed in which, for example, in order to inform the user of the accurate maintenance timing for a component mounter, the maintenance inspection timing for the component mounter is judged from production inspection condition data which is based on multifaceted information obtained from the use condition of a cartridge and an electronic component mounter, and informed to the component mounter user when such inspection timing has come (for example, see Japanese Laid-Open Patent Application No. 11-150398 Publication).

Furthermore, there is disclosed a service supply method, and so on, for providing maintenance parts information and the inventory information thereof, providing maintenance information and maintenance manuals, as well as providing software version upgrade information between the component mounter supplier and the servicing agent via a communication means such as the Internet (for example, see Japanese Patent No. 3583099).

However, even when the user of the component mounter attempts to carry out countermeasures for the occurrence of trouble in advance, the period of use of component mounters are varied, and the user is unable to recognize the appropriate support details corresponding to the period of use, which can be availed of from the manufacturer of the component mounter. In other words, there are many cases where the occurrence of trouble can be prevented and the performance of the currently used component mounter can be improved when the details of the newest service which corresponds to the period of use of the component mounter, provided by the manufacturer is carried out. However, in spite of this, the actual situation is that even from the management standpoint, unseen significant losses are incurred since the user is unable to accurately comprehend the support information.

Furthermore, although in many instances the performance of the component mounter being used can be improved when new support details provided by the manufacturer are carried out, there are many cases where the component mounter user is unable to accurately comprehend the details of new support technology provided by the manufacturer, and there is the problem that even from the management standpoint, unseen losses are incurred.

Meanwhile, on the side of the component mounter manufacturer, in a situation where the models of the component mounters used by each user is significantly different, the means for accurately conveying model-classified systematic service details that can be provided for the respective component mounter used by the user is currently limited to paper-based means such as a catalogue, and there is the problem that improvement details are not immediately conveyed to the user.

In addition, it is common for the user of the component mounter to set a fixed time for yearly operational planning and account for expenses necessary to maintain the component mounter for one year. However, conventionally, expense schedules are created based on past expenses, and so on, without considering the period of use of the component mounter, so that there are many cases where the actual expenses incurred are significantly different from that in the schedule, which poses a problem on the side of the component mounter user. In other words, currently, the appropriate setting of budget plans which is in accordance with the period of use of the component mounter is not being carried out.

### SUMMARY OF THE INVENTION

The present invention is conceived in order to solve the aforementioned conventional problems and has as an object to provide a supply apparatus that supplies appropriate support information according to the period of use from the start of use of the production apparatus being used, and a receiving apparatus that receives the support information for the performance of appropriate maintenance according to the period of use of the production apparatus, based on such support information.

In order to solve the aforementioned problems, the receiving apparatus according to the present invention is a receiving apparatus that receives support information regarding maintenance of a production apparatus, the receiving apparatus including: a communication unit which receives the support information, via a network, from a supply apparatus that supplies the support information; a display unit which displays the support information; a storage unit which stores the support information; and an acceptance unit which accepts, from a user of the receiving apparatus, an input instruction regarding the support information, wherein the support information describes at least a relationship between a period of use of the production apparatus and a support item for the production apparatus which is in accordance with the period of use.

With this structure, the receiving apparatus according to the present invention is able to receive, via the communication unit, the appropriate support information which is in accordance with the period of use, from the start of use, of the production apparatus being used, and maintenance which is in accordance with the period of use of the production apparatus can be carried out based on the support information.

Furthermore, the supply apparatus according to the present invention is a supply apparatus that supplies support information regarding maintenance of a production apparatus, to a receiving apparatus that receives the support information, the supply apparatus including: a second communication unit which transmits the support information, via a network, to the receiving apparatus; a second storage unit which stores the support information; and an updating unit which updates the support information, wherein the support information describes at least a relationship between a period of use of the production apparatus and a support item for the production apparatus which is in accordance with the period of use.

With this structure, the supply apparatus according to the present invention is able to supply to the receiving apparatus, via the second communication unit, the appropriate support information which is in accordance with the period of use, from the start of use, of the production apparatus being used.

Note that, in order to achieve the aforementioned object, the present invention can also be implemented as a receiving method and a supply method having, as steps, the characteristic component units of the receiving apparatus and the supply apparatus, respectively, and also as a program which includes all of such steps. In addition, aside from being stored in a ROM, and the like, included in the receiving apparatus and supply apparatus, such program may also be distributed via a recording medium, such as a CD-ROM and the like, and also via a communication network.

Moreover, in order to achieve the aforementioned object, the receiving apparatus may also be included in a production apparatus.

With the supply apparatus and receiving apparatus according to the present invention, a user of a production apparatus such as a component mounter is able to visually comprehend accurate support information in accordance with the period of use of the production equipment, and the effect of being able to carry out more appropriate maintenance is achieved.

### FURTHER INFORMATION ABOUT TECHNICAL BACKGROUND TO THIS APPLICATION

The disclosure of Japanese Patent Application No. 2005-352689 filed on Dec. 6, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a general view for the case where the supply apparatus at the component mounter manufacturer-side and the receiving apparatus included in the component mounter, at the component mounter user-side are connected via a telecommunication unit such as the Internet.

FIG. 2 is a reference diagram for the case where the support information for the component mounter is supplied, via an information recording medium, to an information recording medium reading apparatus set at the user of the component mounter.

FIG. 3 is an explanatory diagram for the notification of service information between the supply apparatus and the receiving apparatus according to the present invention.

FIG. 4 is a function block diagram of the control unit included in the receiving apparatus according to the present invention.

FIG. 5 is a reference diagram showing an example of a search mode screen displayed on the display unit of the receiving apparatus.

FIG. 6 is a reference diagram showing an example of support information displayed in the display unit of the receiving apparatus according to the present invention.

FIG. 7 is a reference diagram showing an example of a preventive maintenance program displayed in the display unit of the receiving apparatus according to the present invention.

FIG. 8 is a reference diagram showing an example of a rough estimate displayed in the display unit of the receiving apparatus according to the present invention.

FIG. 9 is a reference diagram showing another example of support information according to the present invention.

FIG. 10 is a reference diagram showing another example of support information according to the present invention.

FIG. 11 is an explanatory diagram for the case where the component mounter user side is configured of a plurality of factories.

FIG. 12 is a reference diagram showing an example of the search mode screen displayed on the display unit of the receiving apparatus, in accordance with FIG. 11.

FIG. 13 is a reference diagram showing an example of an equipment delivery list displayed on the display unit of the receiving apparatus according to the present invention.

FIG. 14 is a reference diagram showing an example of a total rough estimate displayed on the display unit of the receiving apparatus according to the present invention.

FIG. 15 is a reference diagram showing an example of a search mode screen displayed on the display unit of the receiving apparatus according to the second embodiment.

FIG. 16 is a reference diagram showing an example of support information provided from the supply apparatus to the receiving apparatus, and displayed on the display unit of the receiving apparatus according to the second embodiment.

FIG. 17 is a reference diagram showing another example of support information provided from the supply apparatus to the receiving apparatus, and displayed on the display unit of the receiving apparatus according to the second embodiment.

FIG. 18 is a reference diagram showing an example of a rough estimate displayed on the display unit of the receiving apparatus according to the present invention.

FIG. 19 is a reference diagram showing an example of a search mode screen displayed on the display unit of the receiving apparatus according to the present invention.

FIG. 20 is a reference diagram showing an example of support information displayed in the display unit of the receiving apparatus according to the present invention.

### DESCRIPTION OF THE PREFERRED EMBODIMENT(S)

Hereinafter, the receiving apparatus and the supply apparatus according to the present invention shall be described with reference to the diagrams.

### First Embodiment

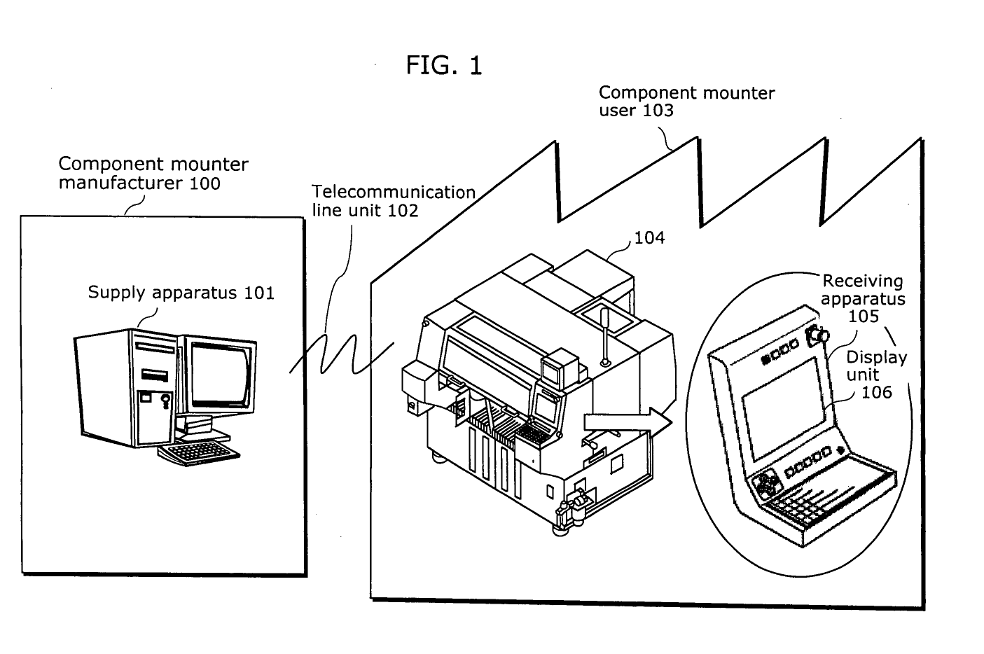

FIG. 1 shows a general view of the case where a supply apparatus 101 of a component mounter manufacturer 100 is connected to a receiving apparatus 105 included in a component mounter 104 of a component mounter user 103, via a telecommunication line unit 102 such as the Internet, according to the present invention.

Moreover, the present invention is characterized by the provision of support information in the form of a time-line matching the life cycle serving as the period of use from the start of use of the component mounter being used, from the supply apparatus 101 of the component mounter manufacturer 100, to the component mounter user 103 using the receiving apparatus 105. Note that in the diagram, the support information is transmitted by the component mounter manufacturer 100, from the supply apparatus 101 such as a management server, via a telecommunication line unit such as the Internet.

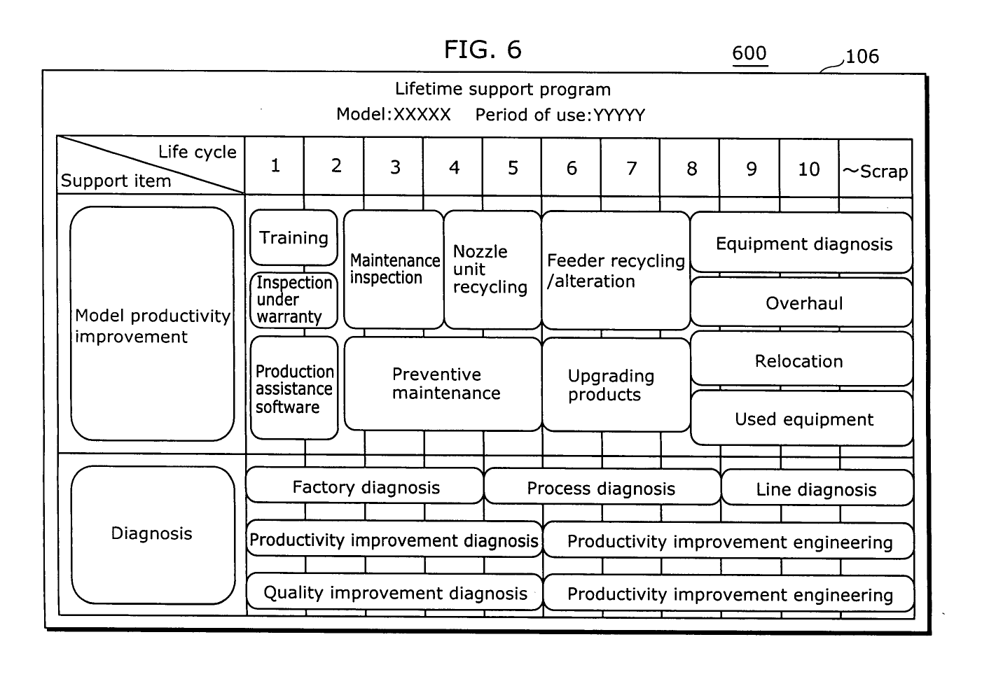

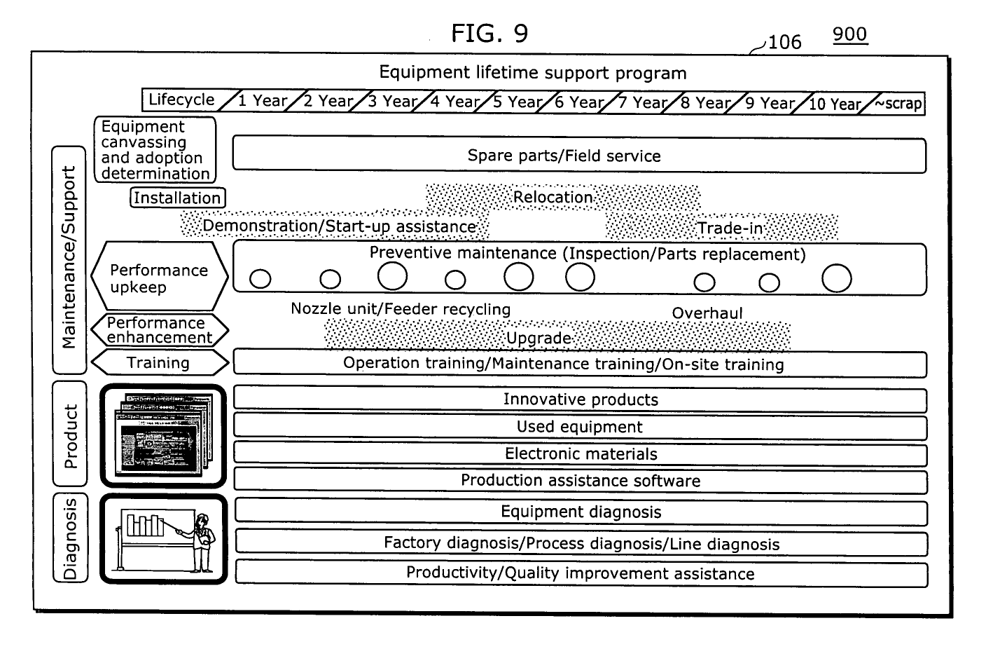

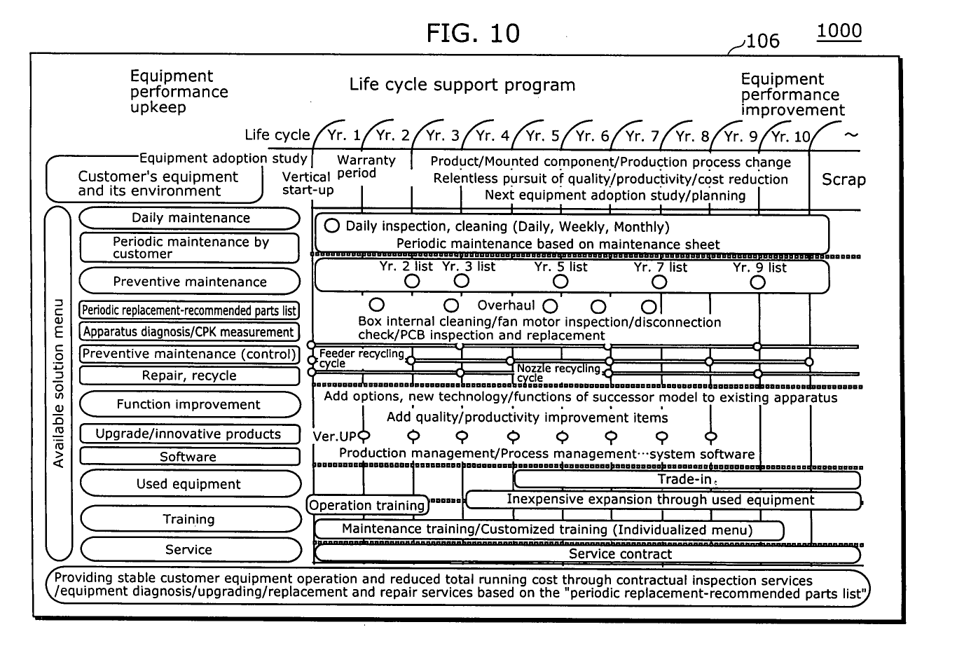

Furthermore, the receiving apparatus 105 receives the support information from the supply apparatus 101, and the component mounter user 103 can visually comprehend the time-linear support information for the component mounter, using a display unit 106 such as a liquid-crystal screen. Note that description of the support information according to the present invention shall be made using FIG. 6, FIG. 9, and FIG. 10 as discussed later.

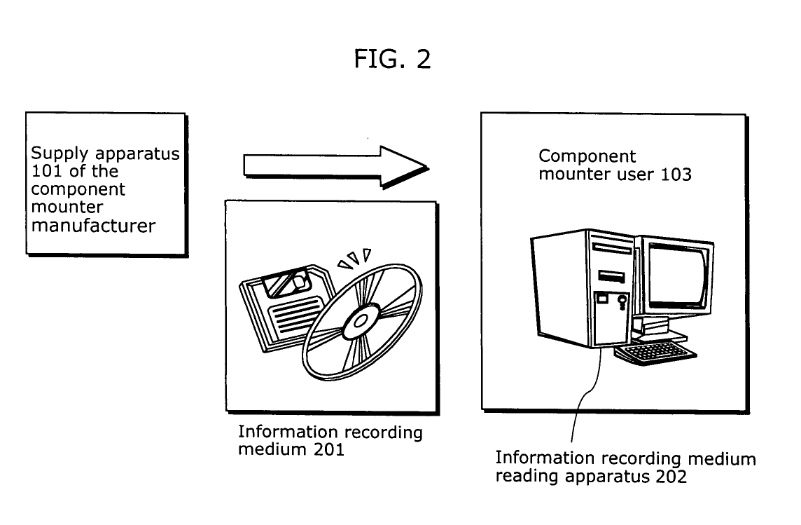

FIG. 2 is a reference diagram for the case where the support information for the component mounter is supplied, via an information recording medium 201, to an information recording medium reading apparatus 202 equipped at the component mounter user 103. Note that in the diagram, the information recording medium reading apparatus 202 is a receiving apparatus including a reading unit for reading a CD-ROM and the like. The receiving apparatus 105 for FIG. 2 may also be an apparatus such as a personal computer owned by the component mounter user 103, which is independent of the production apparatus.

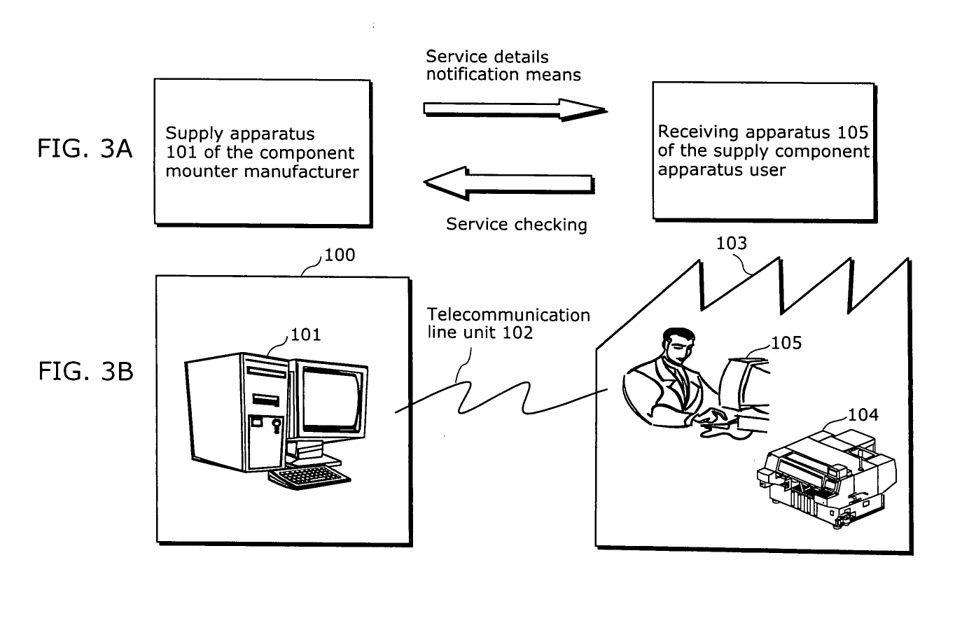

FIG. 3 is an explanatory diagram for the notification of service information between the supply apparatus 101 and the receiving apparatus 105 according to the present invention. When service information is notified from the supply apparatus 101, the component mounter user 103 is able to check the details of the service information. Note that the receiving apparatus 105 in FIG. 3 may also be an apparatus such as a personal computer owned by the component mounter user 103, which is independent of the production apparatus.

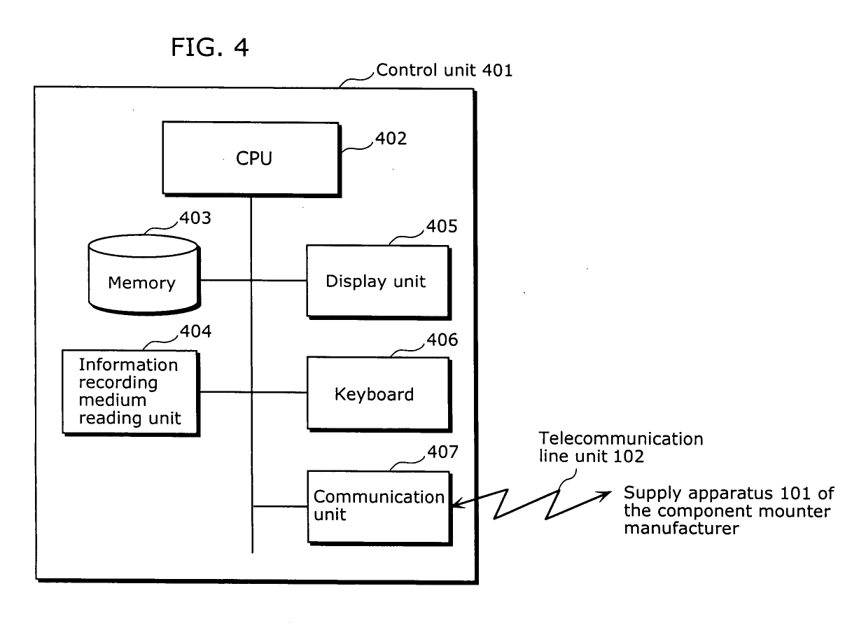

FIG. 4 shows, for the case where the receiving apparatus is provided in the production apparatus, a function block diagram of a control unit 401 included in the receiving apparatus 105 according to the present invention.

The control unit 401 is built into the component mounter in advance and includes: a CPU 402; a memory 403 for recording received support information; an information recording medium reading unit 404 which reads support information from a recording medium such as a CD-ROM and the like; a display unit 405 such as a screen for displaying support information to the user; a keyboard 406 for receiving, from the component mounter user, input instructions for information regarding support information; and a communication unit 407 for carrying out communication with the supply apparatus 101 at the manufacturer of the component mounter, via a network. Note that it is possible to automatically update the support information recorded in the memory 403 with the newest information as appropriate.

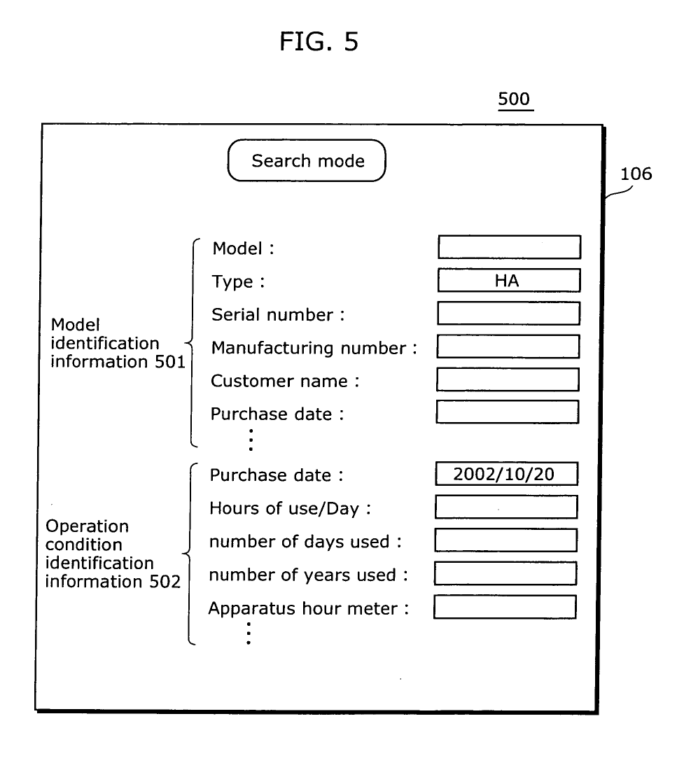

FIG. 5 is a reference diagram showing an example of a search mode screen 500 displayed in the display unit 106 of the receiving apparatus 105.

In the search mode screen 500, the user is required to input “model identification information 501” and “operating condition identification information 502” of the component mounter being used, in order to receive the optimal support information needed by the user.

Here, “model identification information 501” refers to information identifying the model of the component mounter used by the user, and may be at least one of a model, type, serial number, manufacturing number, customer number, purchase date, and the like, or a combination thereof. Furthermore, “operating condition identification information 502” refers to information identifying the use condition of the model used by the user, and may be at least one of a purchase date, hours of use/day, number of days used, number of years used, and an apparatus hour meter, and the like, or a combination thereof.

FIG. 6 is a reference diagram showing an example of support information 600 displayed in the display unit 106 of the receiving apparatus 105 according to the present invention. Note that the time-linear support information according to the present invention is not limited to the details in the diagram, and other forms are possible as long it allows the relationships between the component mounter's life cycle and the support items to be viewed at a glance. The support information shown in FIG. 9 and FIG. 10, as described later, are also examples thereof.

In FIG. 6 support information which is in accordance with the life cycle of the component mounter is displayed on the display 106, as a lifetime support program for the component mounter. Support items are placed on the vertical axis and the life cycle on the horizontal axis as a basis, in accordance with the component mounter's model and life cycle, so that it can be viewed at a glance by the user.

For example, in the support information 600 received by the receiving apparatus 105, the periods after the purchase of the component mounter is displayed in the life cycle, and a list of apparatus productivity improvement-related items as well as diagnosis-related items are displayed as support items which are predicted for the expected periods of use. Moreover, as apparatus productivity improvement-related items, optimal support information for each year of use of the component mounter are indicated such as: “training” for training the component mounter user; “Inspection under warranty” for inspection within the warranty period; “maintenance inspection” for inspection under a contract, and “nozzle unit recycling” corresponding to the timing for recycling of the nozzle unit.

Furthermore, items such as “productivity improvement diagnosis” for diagnosing the productivity of the factory, and “quality improvement diagnosis” for verifying the quality of substrates produced by the component mounter are listed as diagnostic items.

Note that the life cycle which is used in the diagram need not be the number of years, and may be in terms of time or other appraisable items such as information based on the rate of operation of the component mounter. Furthermore, by managing the support information in the supply apparatus 101 at the component mounter manufacturer 100 side, updating with the newest support information for each individual component mounter can be carried out at all times.

In addition, with regard to maintenance that is actually performed, colors are changed in the display during the displaying of support information so that it is possible to further visually emphasize the maintenance condition to the user. Furthermore, by double-clicking on the actually performed maintenance information, the user can find out the details of such maintenance.

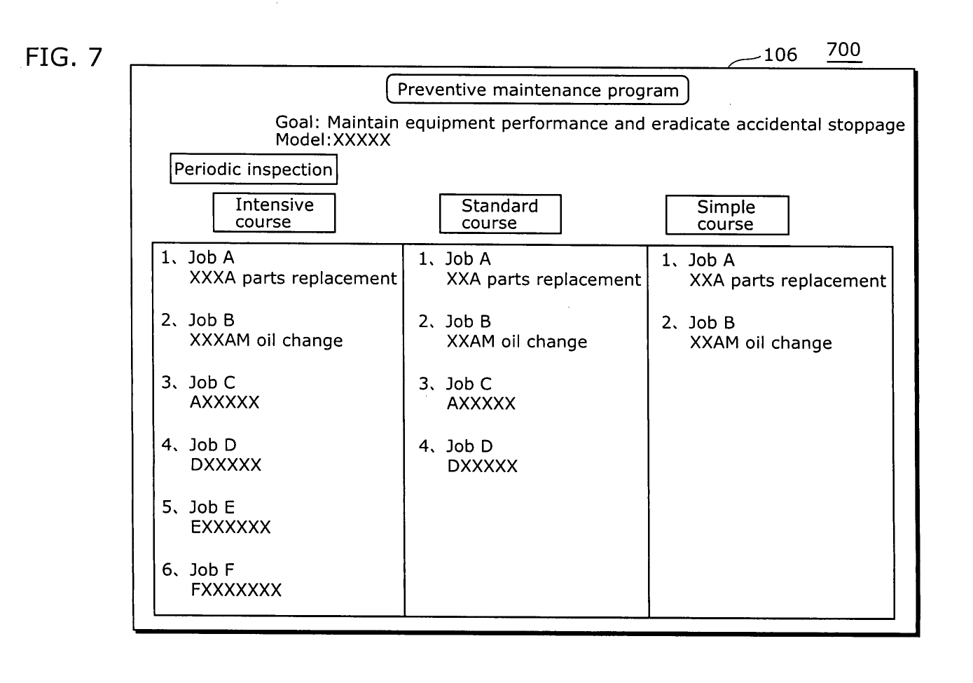

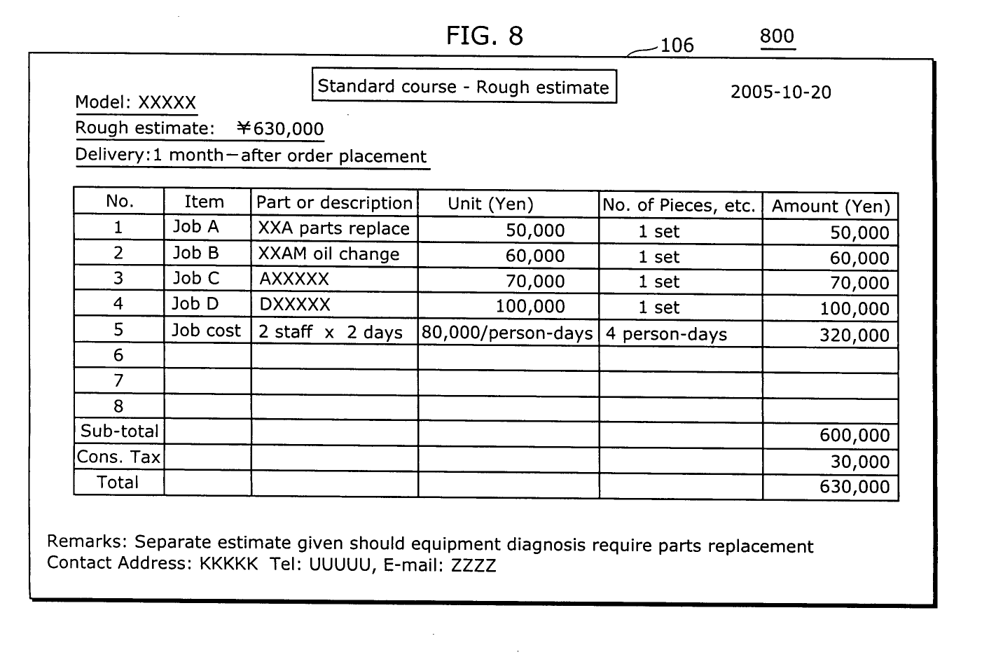

Furthermore, the user of the receiving apparatus 105 according to the present invention can, at the same time, obtain from the supply apparatus 101, information necessary for the availing of services such as the delivery date and points of contact, using a preventive maintenance program 700 indicating a standard inspection course, and a rough estimate 800, as shown in FIG. 7 and FIG. 8 respectively.

FIG. 9 is a reference diagram showing support information 900 which is another example of support information according to the present invention.

In the diagram, the relationship between the life cycle of the component mounter and the support details are displayed, as a support program for the apparatus, in a manner which allows viewing at a glance. In addition, in the support information 900 shown in FIG. 9, equipment canvassing and adoption determination, installation, performance upkeep, performance enhancement, and training are included in the maintenance/support-related items, and aside from this, time-linear support details related to product and diagnosis are indicated.

FIG. 10 s a reference diagram showing support information 1000 which is another example of support information according to the present invention.

In the diagram, the relationship between the life cycle of the component mounter and the support details are displayed as a “life-cycle program” for equipment performance upkeep and equipment performance improvement, in a manner which allows viewing at a glance. In addition, in the support information 1000 shown in FIG. 10, details such as daily maintenance, periodic maintenance by customer, preventive maintenance, periodic replacement-recommended parts list, equipment diagnosis/CPK measurement, preventive maintenance (control), repair/recycling, function improvement, upgrade/innovative products, software, used equipment, training, and service are included as an available solution menu. Aside from this, time-linear details related to the customer's equipment and the environment thereof is also included.

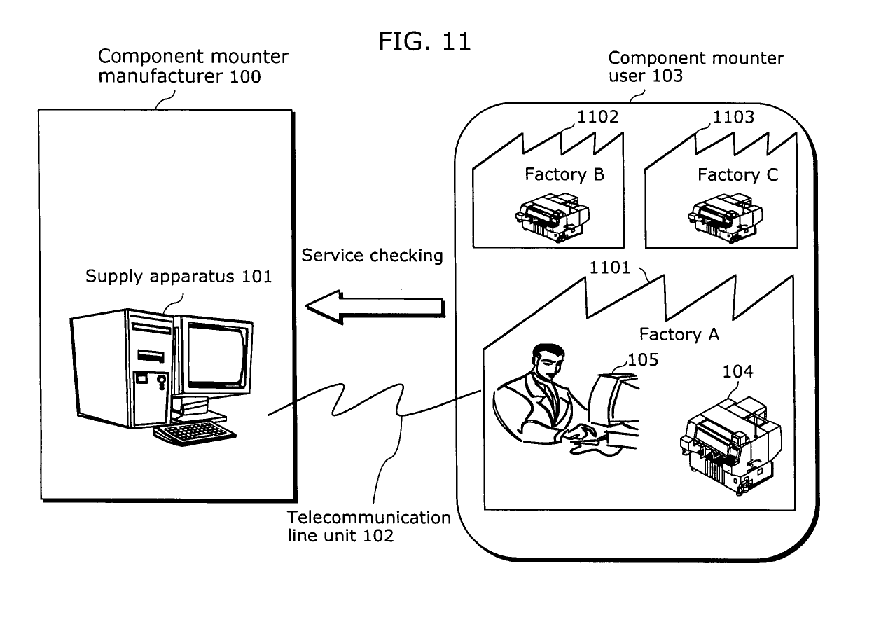

FIG. 11 is an explanatory diagram for the case where the component mounter user 103 is configured of a plurality of factories 1101, 1102 and 1103.

As shown in the diagram, in the case of a large company, the receiving apparatus 105 can be provided with time-linear service information which also takes into consideration information on component mounters of plural factories, and in the case where overseas factories are included, the details thereof as well. It is preferable that the receiving apparatus 105 in FIG. 11 be an apparatus, such as a personal computer owned by the component mounter user 103, which is independent of the production apparatus.

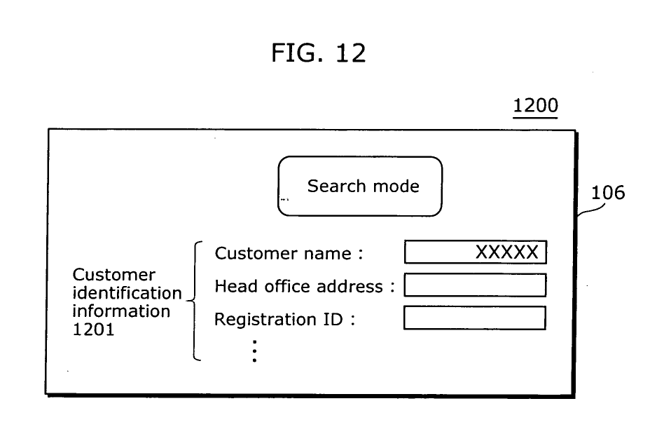

FIG. 12 is a reference diagram showing an example of a search mode screen 1200 displayed on the display unit 106 of the receiving apparatus 105, in accordance with FIG. 11. Here, “customer identification information 1201” refers to information for identifying the user and may be at least one from among information such as a customer name, head office address, and registration ID, or information which identifies the user based on information which is a combination of the aforementioned items, and the like.

Note that in the first embodiment, since the exchange or support information is carried out using the telecommunication line unit 102, it is common that between the component mounter manufacturer 100 and the component mounter user 103, the supply apparatus 101 and the receiving apparatus 105 are connected, under contract, based on an ID and password for each user, as shown in the diagram.

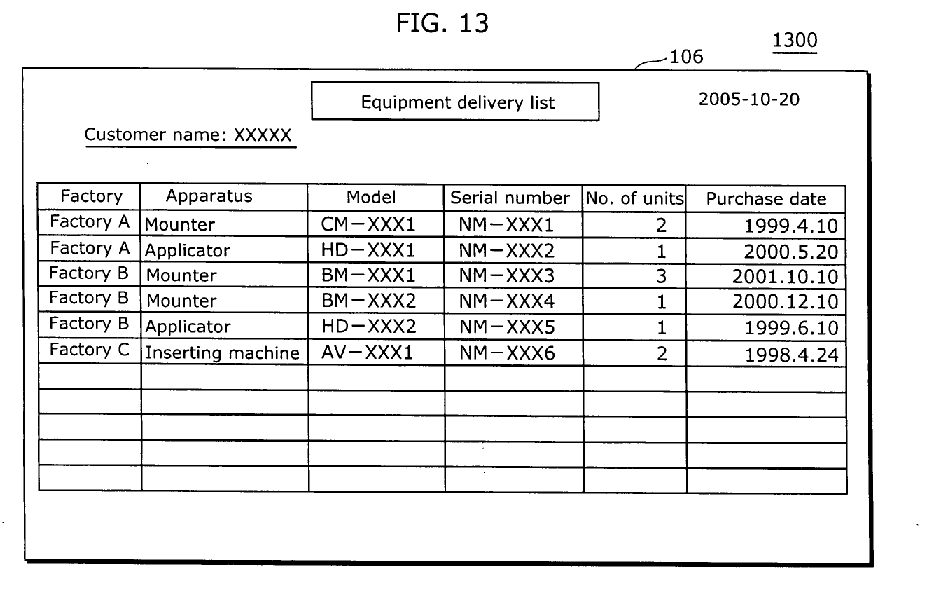

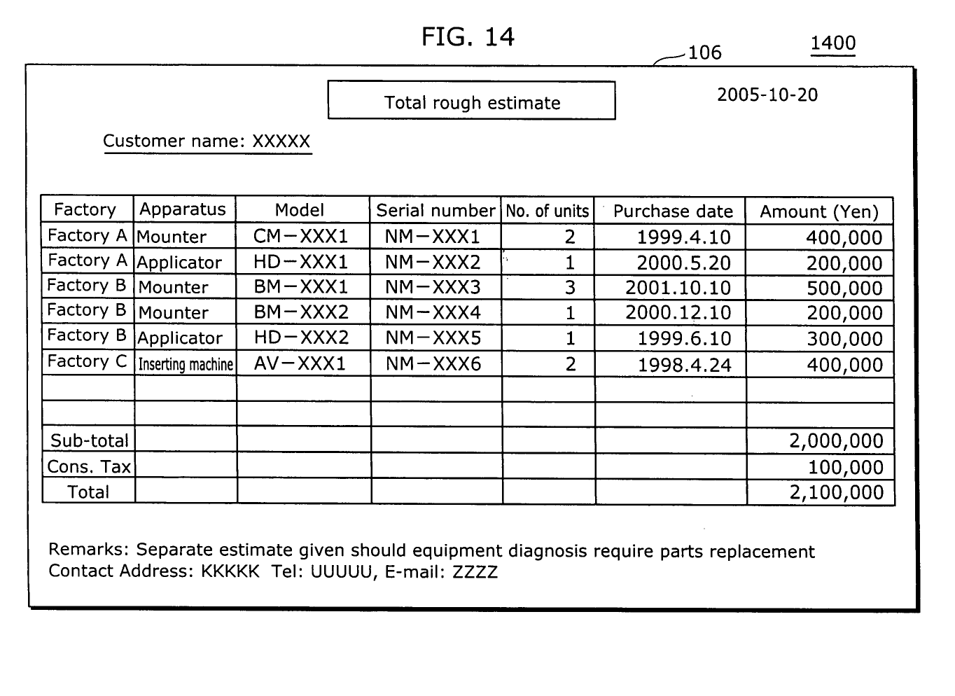

Furthermore, the component mounter user 103 using the receiving apparatus 105 according to the present invention can obtain on-line, from the supply apparatus 101, an equipment delivery list 1300 and a total rough estimate 1400 as shown in FIG. 13 and FIG. 14 respectively.

As described thus far, in the first embodiment, by using the receiving apparatus 105 to obtain support information indicating the relationship between the life cycle and support items, the component mounter user 103 is able to visually grasp at a glance the time-linear service details, which are in accordance with the life cycle of the component mounter, that can be availed from the manufacturer 100 of the component mounter being used, and is thus able to easily select the service details that are deemed necessary.

Furthermore, since the service information provided matches the life cycle of the component mounter used by the user, when the component mounter being used reaches the timing for preventive maintenance for example, the component mounter can receive planned maintenance servicing. Therefore, before the component mounter stops due to trouble, it can be stopped and worked on according to a plan, and thus enabling the setting up of a production plan.

In addition, the user may be able to keep track of the performance of individual component mounters and study the improvement of productivity in the case where there are a few component mounters being used. However, by availing of the provision of services such as that in the present invention, it is possible to recognize at a glance the service details for availing diagnosis which enables factory improvement and productivity improvement, and activities that can improve total factory productivity can be carried out smoothly, even in the case where the number of component mounters used increases.

Furthermore, even with regard to business planning, it is possible for the user to more accurately grasp the service details and costs deemed necessary for the next year, and thus incorporation into the business plan and financial studies can be sufficiently carried out.

In addition, even in the case where the life cycle of the component mounter is exceeded, the user can recognize at a glance conditions such as replacement, relocation, and reselling as used equipment, and so on, and thus plans for subsequent investments can be incorporated into the business plan.

Further still, aside from the user who uses the component mounters in various factories, it is possible to chronologically provide necessary information to an administrator tasked with management, and thus contribute greatly to management.

Note that although in the first embodiment, description is carried out with the support information being obtained by the component mounter user 103, it is also possible to have a configuration in which the support information is relayed from the component manufacturer 100 to the user in advance, and used by the user 103.

Furthermore, although in the first embodiment, description is carried out using, as the period of use, life cycle after purchase of the component mounter aside from this, it is also possible to consider the actual life cycle which excludes the time in which the component is not actually in use, or a life cycle which is in accordance with the rate of operation of the component mounter.

### Second Embodiment

Hereinafter, the second embodiment of the supply apparatus and the receiving apparatus according to the present invention shall be described with reference to the diagrams.

Note that the second embodiment is characterized in that model-classified systematic upgrading-related service information for the component mounters being used is provided to the user from the manufacturer of the component mounter. Furthermore, since the configuration of the supply apparatus and the receiving apparatus is the same as that in the aforementioned first embodiment, such explanation shall be omitted.

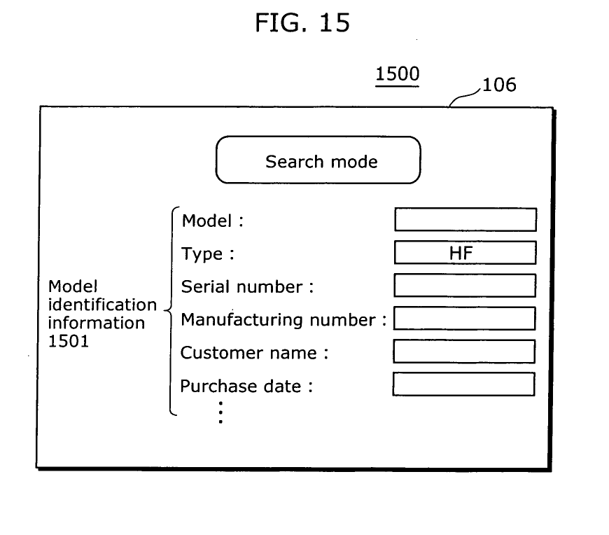

FIG. 15 is a reference diagram showing an example of the search mode screen 1500 displayed in the display unit 106 of the receiving apparatus.

The user can search for upgrading-related support information for each model by inputting search information such as the details of model identification information 1501 which are, for example, model, type, serial number, and the like.

Moreover, “model identification information 1501” refers to information identifying the model used by the user and may be at least one from among information such as a model, type, serial number, manufacturing number, customer number, purchase date, and the like, or information which identifies the model used by the user based on information which is a combination of the aforementioned items, and the like.

Furthermore, the “model” shown in FIG. 15 is a model which falls within the model-classified systematic improvement service details provided by the manufacturer 100 of the production apparatus. When a model is sold, the manufacturer 100 terminates production of such model when a certain number of years have elapsed then sells a component mounter which serves as a successor model; and such combination of the series having such successor model is referred to in “model”.

Furthermore, although it is likewise described in the second embodiment that support information is supplied from the supply apparatus 101 via a telecommunication line unit such as the Internet, it is also possible to have other means where, for example, the provision is carried out through an information recording medium such as a CD-ROM. In addition, it is also possible for such support information to be stored in a storage unit of the receiving apparatus 105.

Note that, in the case where provision is carried out using an electronic telecommunication line unit, it is common to have a format in which the service providing apparatus is connected, under contract, with an identification means such as a customer-specific ID, password, and the like, between the manufacturer of the production apparatus and the user.

Furthermore, although it is described in the second embodiment that the model-classified systematic improvement support information is searched for by the user himself, it is also possible to have the model-classified systematic improvement support information notified from the manufacturer of the component mounter to the user in advance, and then used by the user.

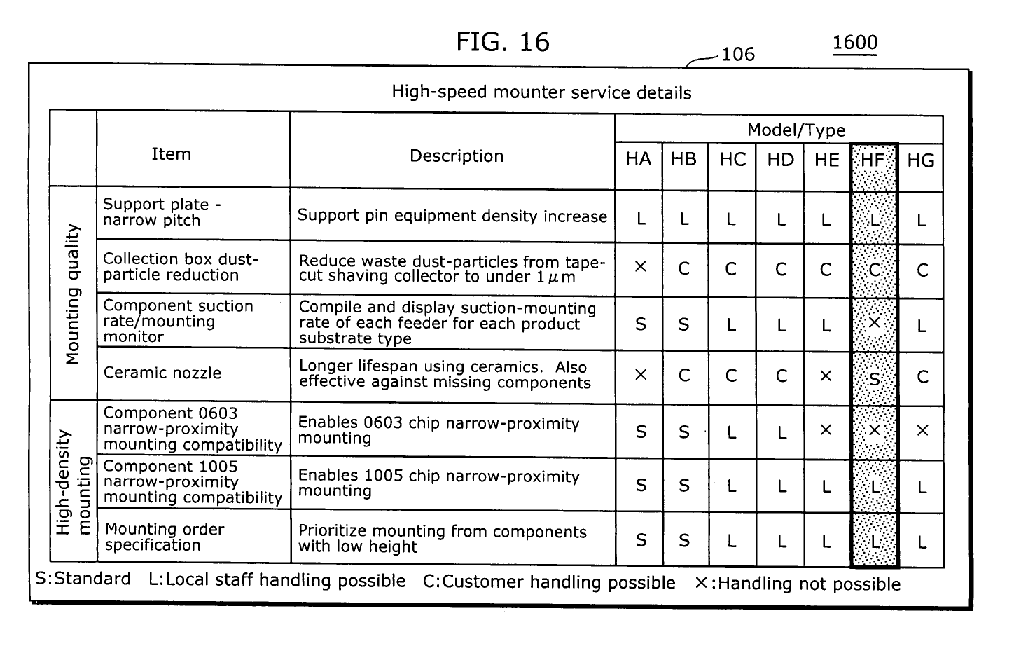

FIG. 16 is a reference diagram showing an example of support information 1600 provided from the supply apparatus to the receiving apparatus, and displayed on the display unit 106 of the receiving apparatus according to the second embodiment.

In the support information 1600 shown in the diagram, service details for a high-speed mounter are indicated. For example, items related to mounting quality and items related to high-density mounting for each model/type of component mounter are described on the vertical axis, and item, description, and model/type are described on the horizontal axis. Furthermore, in the diagram, classifications are displayed, such as: “S” indicating that version upgrade items are included as standard equipment; “L” indicating that the item can be handled by local technical staff; “C” indicating that the item can be handled by the user; and “X” indicating that handling is not possible.

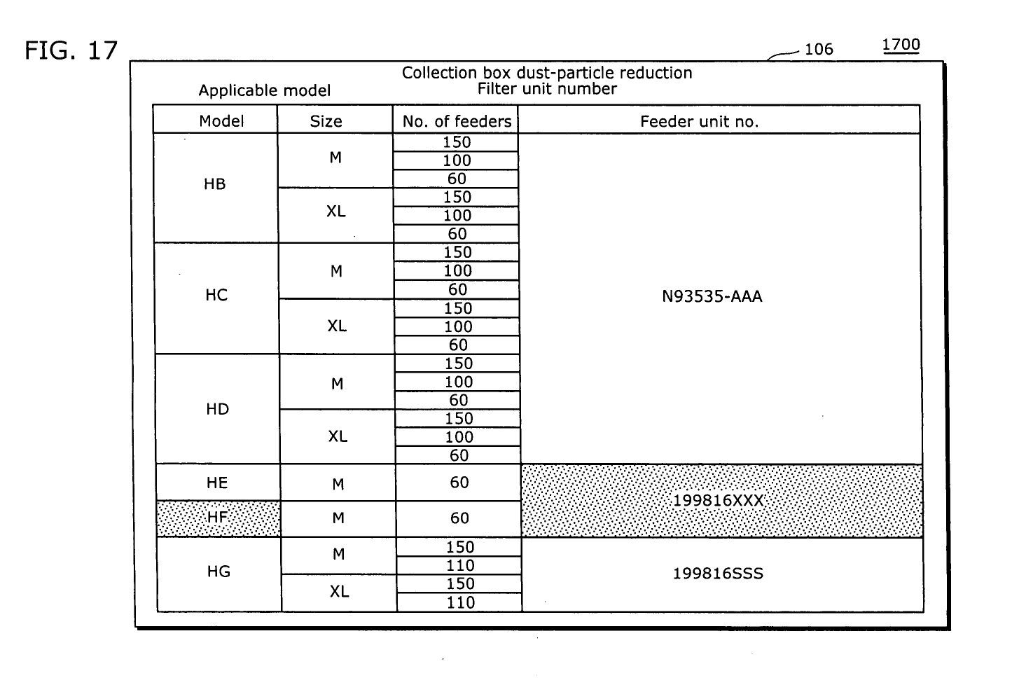

FIG. 17 is a reference diagram showing support information 1700 which is another example of support information provided from the supply apparatus to the receiving apparatus, and displayed on the display unit 106 of the receiving apparatus according to the second embodiment. In the support information 1700 shown in the diagram, information related to collection box dust-particle reduction is described, and information such as sizes that can be utilized for each model and the number of feeders is indicated.

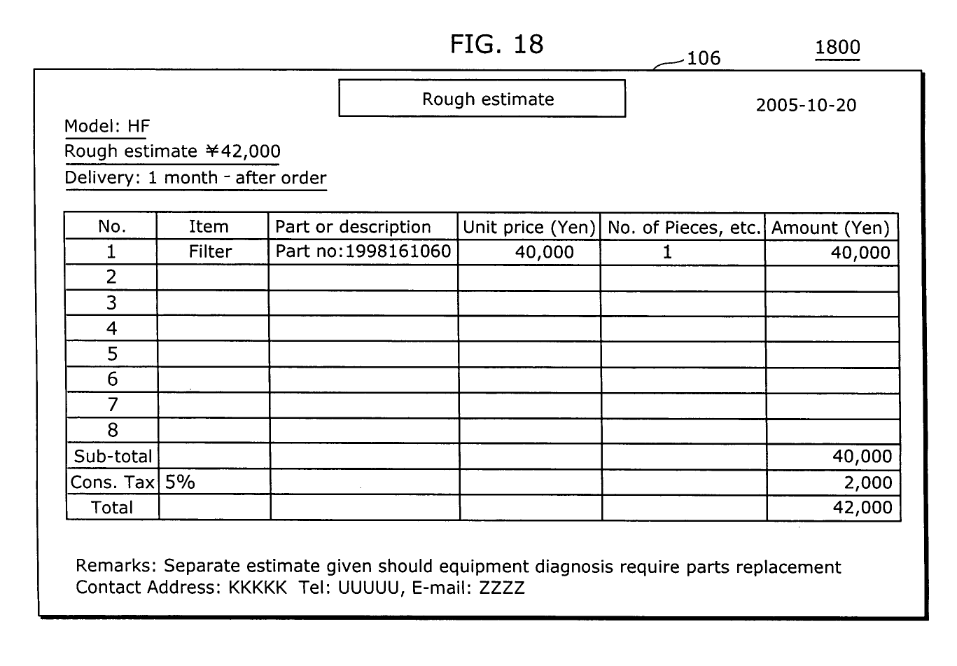

Furthermore, by the placement of an order for version upgrading by the component mounter user 103, via the support information screen, a rough estimate 1800 as shown in FIG. 18 is supplied from the supply apparatus via a network. With this, the component mounter user 103 can obtain, altogether, information for availing services, such as a rough estimate, delivery date, and contact addresses.

In this manner, in the case where, based on use conditions, the component mounter being used is in a state which allows its upgrading and usage, selecting a version upgrade product from the service details makes it is possible to recognize at a glance which details can be availed of, rough estimates for the version upgrade can be easily understood, and it is possible to compare the investment with the productivity increase and easily decide whether or not to invest.

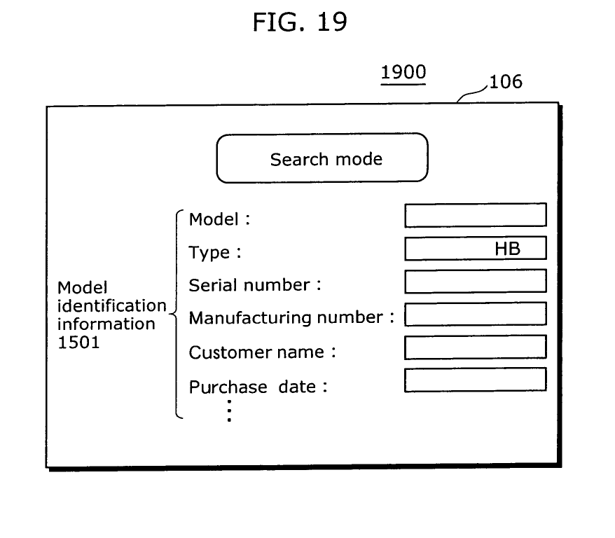

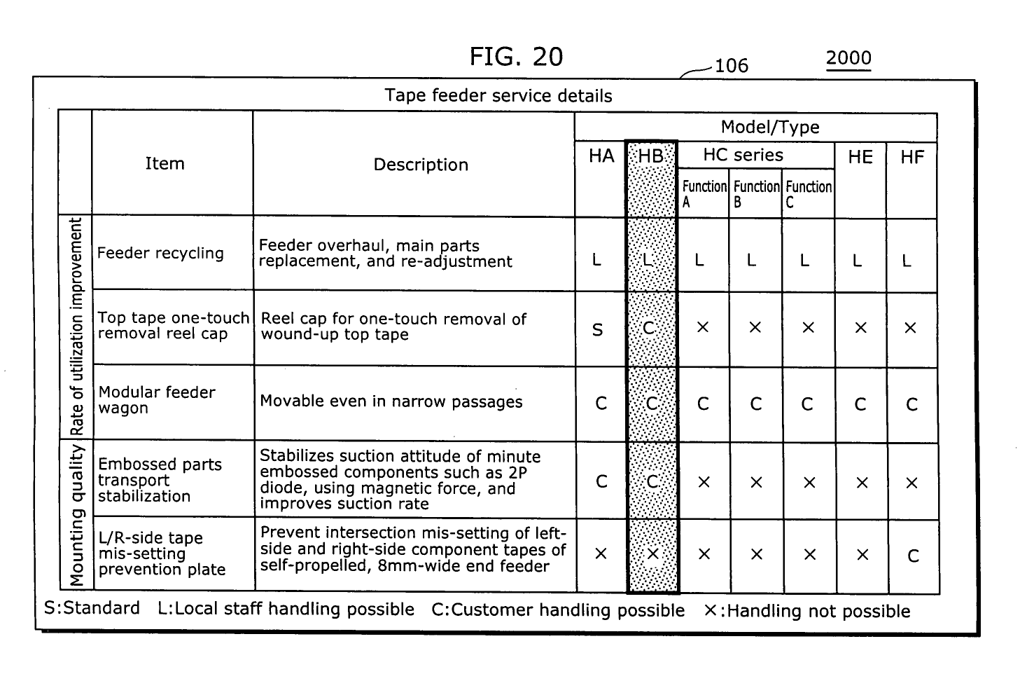

FIG. 19 and FIG. 20 show support information 2000, in the case where version upgrade information of a model having a different type (tape feeder service details, in FIG. 20) is searched by inputting model identification information via a search mode screen 1900 displayed on the display unit 106 of the receiving apparatus.

Moreover, as previously described, the receiving apparatus may be included in the production apparatus, or it may be an apparatus such as a personal computer owned by the user 103 of the component mounter, which is independent of the production apparatus, or a receiving apparatus purpose-built as a receiving apparatus.

As described thus far, in the second embodiment, the user of the component mounter is able to comprehend at a glance the support information related to model-classified systematic version upgrades that can be availed from the manufacturer of the component mounter being used. In addition, the user can select, from such service details, the service details related to version upgrades that are deemed necessary.

Furthermore, since the provided support information provides the newest model-classified systematic improvement service details that can be availed by the component mounter used by the user, the user can avail of the newest service, and the increase and improvement of performance can be carried out systematically.

For example, assume that the model currently used by the user is a model “HF”. Although this model can only handle components up to a component “1608 chip”, by availing of the provided model-classified systematic support information according to the present invention, it becomes possible to recognize the fact that this model can be version upgraded to mount up to a “1005 chip”, and handle the “1005 chip” without having to purchase a new model. In addition, in the case of checking whether or not the currently owned model “HF” can handle a “0603 chip”, it can be known from the support information that such is not possible, and the user can purchase new models “HA” and “HB” which can handle the “0603 chip” or, in the case where “HC” and “HD” models are owned, it becomes possible to recognize at a glance that handling such component can be made possible by availing of the upgrade service.

In addition, even in terms of business planning, it becomes possible for the component mounter user 103 to study whether to purchase next year's new model which is deemed necessary, or to go for a version upgrade for the currently owned model. It becomes possible to easily comprehend the service details and costs and thus incorporation into the business plan and financial studies can be sufficiently carried out.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The receiving apparatus according to the present invention can be used in, for example, a component mounter, a component inserting machine, or a semiconductor mounter, and the supply apparatus according to the present invention can be used, for example, as a server apparatus at a manufacturer of a component mounter and the like.

1. A receiving apparatus that receives support information regarding maintenance of a production apparatus, said receiving apparatus comprising:
a communication unit operable to receive the support information, via a network, from a supply apparatus that supplies the support information;
a display unit operable to display the support information;
a storage unit operable to store the support information; and
an acceptance unit operable to accept, from a user of said receiving apparatus, an input instruction regarding the support information,
wherein the support information describes at least a relationship between a period of use of the production apparatus and a support item for the production apparatus which is in accordance with the period of use.

2. The receiving apparatus according to claim 1,
wherein said acceptance unit is operable to accept, from the user, model identification information which is information for identifying the model of the production apparatus, and
the support information further includes version upgrade information which is based on the model identification information.

3. The receiving apparatus according to claim 2,
wherein said acceptance unit is further operable to accept, from the user, operating condition identification information which is information for identifying an operating condition of the production apparatus with the identified model, and
said communication unit is operable to transmit the model identification information and the operating condition information to the supply apparatus.

4. The receiving apparatus according to claim 1, further comprising
a reading unit operable to read the support information from a recording medium on which the support information is recorded.

5. The receiving apparatus according to claim 1,
wherein the period of use is any of: a post-purchase life cycle of the production apparatus; an actual life cycle which excludes a period in which the production apparatus is not actually used; and a life cycle that is in accordance with a rate of operation of the production apparatus.

6. The receiving apparatus according to claim 1,
wherein the support item includes at least one of items regarding daily maintenance, periodic maintenance, preventive maintenance, a periodic replacement-recommended parts list, apparatus diagnosis, repair, recycling, function improvement, upgrade/innovative products, software, used equipment, training, and service which are in accordance with the period of use of the production apparatus.

7. The receiving apparatus according to claim 1,
wherein the production apparatus is any of a component mounter, a component inserting machine, and a semiconductor mounter.

8. The receiving apparatus according to claim 1,
wherein said receiving apparatus is included in the production apparatus.

9. A supply apparatus that supplies support information regarding maintenance of a production apparatus, to a receiving apparatus that receives the support information, said supply apparatus comprising:
a second communication unit operable to transmit the support information, via a network, to the receiving apparatus;
a second storage unit operable to store the support information; and
an updating unit operable to update the support information,
wherein the support information describes at least a relationship between a period of use of the production apparatus and a support item for the production apparatus which is in accordance with the period of use.

10. The supply apparatus according to claim 9,
wherein said second communication unit is operable to receive, from the receiving apparatus, model identification information which is information for identifying the model of the production apparatus, and
the support information further includes version upgrade information which is based on the model identification information.

11. The supply apparatus according to claim 9,
wherein said second communication unit is further operable to receive, from the receiving apparatus, operating condition identification information which is information for identifying an operating condition of the production apparatus with the identified model,
said update unit is operable to update the support information based on the model identification information and the operating condition identification information, and
said second communication unit is operable to transmit the updated support information to the receiving apparatus.

12. The supply apparatus according to claim 9,
wherein the support item includes at least one of items regarding daily maintenance, periodic maintenance, preventive maintenance, a periodic replacement-recommended parts list, apparatus diagnosis, repair, recycling, function improvement, upgrade/innovative products, software, used equipment, training, and service which are in accordance with the period of use of the production apparatus.

13. The supply apparatus according to claim 9,
wherein the receiving apparatus is included in the production apparatus.

14. A receiving method used in a receiving apparatus that receives support information regarding maintenance of a production apparatus, said receiving method comprising steps of:
receiving support information, via a network, from a supply apparatus that supplies the support information;
displaying the support information;
storing the support information; and
accepting, from a user of the receiving apparatus, an input instruction regarding the support information,
wherein the support information describes at least a relationship between a period of use of the production apparatus and a support item for the production apparatus which is in accordance with the period of use.

15. A supply method for use in a supply apparatus that supplies support information regarding maintenance of a production apparatus, to a receiving apparatus that receives the support information, said supply method comprising steps of:
transmitting the support information, via a network, to the receiving apparatus;
storing the support information; and
updating the support information,
wherein the support information describes at least a relationship between a period of use of the production apparatus and a support item for the production apparatus which is in accordance with the period of use.

16. A support information transferring system comprising a receiving apparatus that receives support information regarding maintenance of a production apparatus and a supply apparatus that supplies support information to said receiving apparatus,
wherein said receiving apparatus includes:
a communication unit operable to receive the support information, via a network, from said supply apparatus that supplies the support information;
a display unit operable to display the support information;
a storage unit operable to store the support information; and
an acceptance unit operable to accept, from a user of said receiving apparatus, an input instruction regarding the support information,
said supply apparatus includes:
a second communication unit operable to transmit the support information, via a network, to said receiving apparatus;
a second storage unit operable to store the support information; and
an updating unit operable to update the support information, and
the support information describes at least a relationship between a period of use of the production apparatus and a support item for the production apparatus which is in accordance with the period of use.

17. The support information transferring system according to claim 16,
wherein said receiving apparatus is included in the production apparatus.

18. A production apparatus which is any of a component mounter, a component inserting machine, and a semiconductor mounter which use at least one of the receiving method according to claim 14 and a supply method for use in a supply apparatus that supplies support information regarding maintenance of a production apparatus, to a receiving apparatus that receives the support information, said supply method comprising steps of:
transmitting the support information, via a network, to the receiving apparatus;
storing the support information; and
updating the support information,
wherein the support information describes at least a relationship between a period of use of the production apparatus and a support item for the production apparatus which is in accordance with the period of use.
